(19) United States
(12) Patent Application Publication
(10) Pub. No.: US 2005/0034298 A1
(43) Pub. Date: Feb. 17, 2005

(54) Disk drive yield optimization by capacity

(75) Inventors: Sridhar Gopalakrishna, San Jose, CA (US); John Joseph Kotla, San Jose, CA (US)

Correspondence Address: Zilka-Kotab, PC, P.O. BOX 721120, SAN JOSE, CA, 95172-1120, US

(73) Assignee: HITACHI GLOBAL STORAGE TECHNOLOGIES

(21) Appl. No.: 10/642,049

(22) Filed: Aug. 15, 2003

(51) Int. Cl. G11B 5/127

(52) U.S. Cl. 29/603.03; 29/603.09

(57) ABSTRACT

A method for manufacturing a disk drive. One or more legacy components, such as heads, are installed in a next generation disk drive of a prespecified capacity. Control parameters of the disk drive are modified so that the drive functions with the legacy head(s) for providing the prespecified capacity.

### FIELD OF THE INVENTION

The present invention relates to methods of manufacture, and more particularly, this invention relates to a method for using legacy heads in next generations of disk drives.

### BACKGROUND OF THE INVENTION

Computer systems generally utilize auxiliary memory storage devices having media on which data can be written and from which data can be read for later use. A direct access storage device (disk drive) incorporating rotating magnetic disks is commonly used for storing data in magnetic form on the disk surfaces. Data is recorded on concentric, radially spaced tracks on the disk surfaces using recording heads. Read heads are then used to read data from the tracks on the disk surfaces. Read and write heads can be formed together on a single slider.

As technology advances, manufacturers of disk drives and/or drive components release new generations of products, each generation having a greater capacity and performance than the previous generation. The current practice is to create and release an entire line of disk drives with next generation components such as heads. When the time between releases is short, e.g., one year, a tremendous strain is placed on the manufacturer. To exemplify, a typical time to create a wafer of disk heads and receive data from drive level testing is six months or more. So, for example, when trying to create a new product line each year, the manufacturer can perform only two wafer turn/testing cycles to optimize the heads for real world conditions. Then the heads must go into full production in order to meet production demands. As will be apparent to those skilled in the art, this creates a great strain on the engineers who develop and test the heads as well as the fabrication facilities that must adjust wafer processing parameters in light of testing results and then ramp up the production line to produce large quantities of heads in a short time. What is therefore needed is a way to reduce the need for fast ramp up and production of large quantities of heads and other disk drive components for each generation of disk drive that is released.

Manufacturers often discontinue older product lines in favor of the next generation of drives, abandoning the entire manufacturing line for the prior product. Thus, much if not all of the money and time spent developing the older devices and creating the manufacturing processes are discarded. What is needed is a way to extend the life of disk drive components by implementing legacy components in next generations of disk drive systems while maintaining the capacity and performance advantages provided by the next generation disk drive systems.

### SUMMARY OF THE INVENTION

The present invention overcomes the drawbacks and limitations described above by providing a method for manufacturing a disk drive. One or more legacy components, such as heads, are installed in a next generation disk drive of a prespecified capacity. Control parameters of the disk drive are modified so that the drive functions with the legacy component(s) for providing the prespecified capacity.

In one embodiment, a second next generation disk drive of the same data capacity but in a same family of drives contains a next generation head. Preferably, a data read and/or write rate of each of the disk drives is about the same. If necessary, two or more legacy heads can be used to achieve the same disk capacity in the first next generation disk drive as is achieved in the second next generation disk drive.

In another embodiment, a second next generation disk drive of a higher data capacity but in a same family of drives contains a next generation head. Legacy heads can be used in about 25-95% of drives in a family of next generation drives.

A method for manufacturing a tape drive includes installing at least one legacy component in a next generation tape drive of a prespecified data rate, and modifying control parameters of the tape drive for functioning with the at least one legacy component for providing the prespecified data rate. The components can include, for example, a read head and/or a write head.

### BRIEF DESCRIPTION OF THE DRAWINGS

For a fuller understanding of the nature and advantages of the present invention, as well as the preferred mode of use, reference should be made to the following detailed description read in conjunction with the accompanying drawings.

FIG. 1 is a perspective drawing of a magnetic disk drive system in accordance with one embodiment.

FIG. 2 is a chart illustrating generations of disk drives using current and legacy components.

### BEST MODE FOR CARRYING OUT THE INVENTION

The following description is the best embodiment presently contemplated for carrying out the present invention. This description is made for the purpose of illustrating the general principles of the present invention and is not meant to limit the inventive concepts claimed herein.

The present invention provides a method of manufacturing next generation disk drives using legacy components. For instance, legacy heads can be used in next generation drives, and yet provide the same performance and capacity as if next generation heads were used while saving costs because the legacy heads are proven heads that the manufacturer already has the capability of producing in bulk.

As used herein, the term “legacy drive” and “legacy head” refers to a drive or read and/or write head that is at least one generation behind a “next generation drive” or “next generation head” implemented in a drive family. A “legacy” family, drive or component can also be defined as products that were created and/or marketed prior to production and/or marketing of the “next generation” family, drive or component. The legacy head may or may not have a lower data read and/or write capability than a next generation head. The term “family” can refer to a group of heads sold under the same product name, advertised as having a particular set of features, etc.

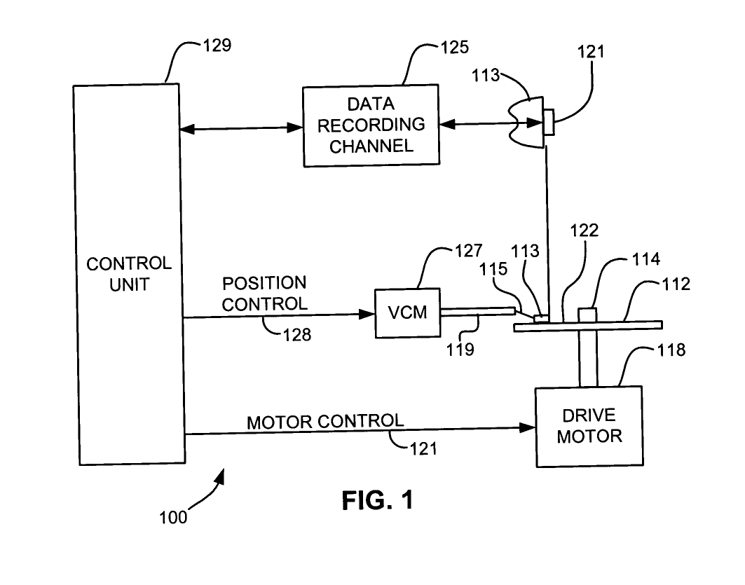

To put the following description in context, a disk drive system is shown in FIG. 1. Referring now to FIG. 1, there is shown a disk drive 100 embodying the present invention. As shown in FIG. 1, at least one rotatable magnetic disk 112 is supported on a spindle 114 and rotated by a disk drive motor 118. The magnetic recording media on each disk is in the form of an annular pattern of concentric data tracks (not shown) on disk 112.

At least one slider 113 is positioned adjacent to the disk 112, each slider 113 supporting one or more magnetic read/write heads 121. As the disks rotate, slider 113 is moved radially in and out over disk surface 122 so that heads 121 may access different tracks of the disk where desired data are recorded. Each slider 113 is attached to an actuator arm 119 by means way of a suspension 115. The suspension 115 provides a slight spring force which biases slider 113 against the disk surface 122. Each actuator arm 119 is attached to an actuator means 127. The actuator means 127 as shown in FIG. 1 may be a voice coil motor (VCM). The VCM comprises a coil movable within a fixed magnetic field, the direction and speed of the coil movements being controlled by the motor current signals supplied by controller 129.

During operation of the disk storage system, the rotation of disk 112 generates an air bearing between slider 113 and disk surface 122 which exerts an upward force or lift on the slider. The air bearing thus counter-balances the slight spring force of suspension 115 and supports slider 113 off and slightly above the disk surface by a small, substantially constant spacing during normal operation.

The various components of the disk storage system are controlled in operation by control signals generated by control unit 129, such as access control signals and internal clock signals. Typically, control unit 129 comprises logic control circuits, storage means and a microprocessor. The control unit 129 generates control signals to control various system operations such as drive motor control signals on line 123 and head position and seek control signals on line 128. The control signals on line 128 provide the desired current profiles to optimally move and position slider 113 to the desired data track on disk 112. Read and write signals are communicated to and from read/write heads 121 by way of recording channel 125.

The above description of a typical magnetic disk storage system, and the accompanying illustration of FIG. 1 are for representation purposes only. It should be apparent that disk storage systems may contain a large number of disks and actuators, and each actuator may support a number of sliders.

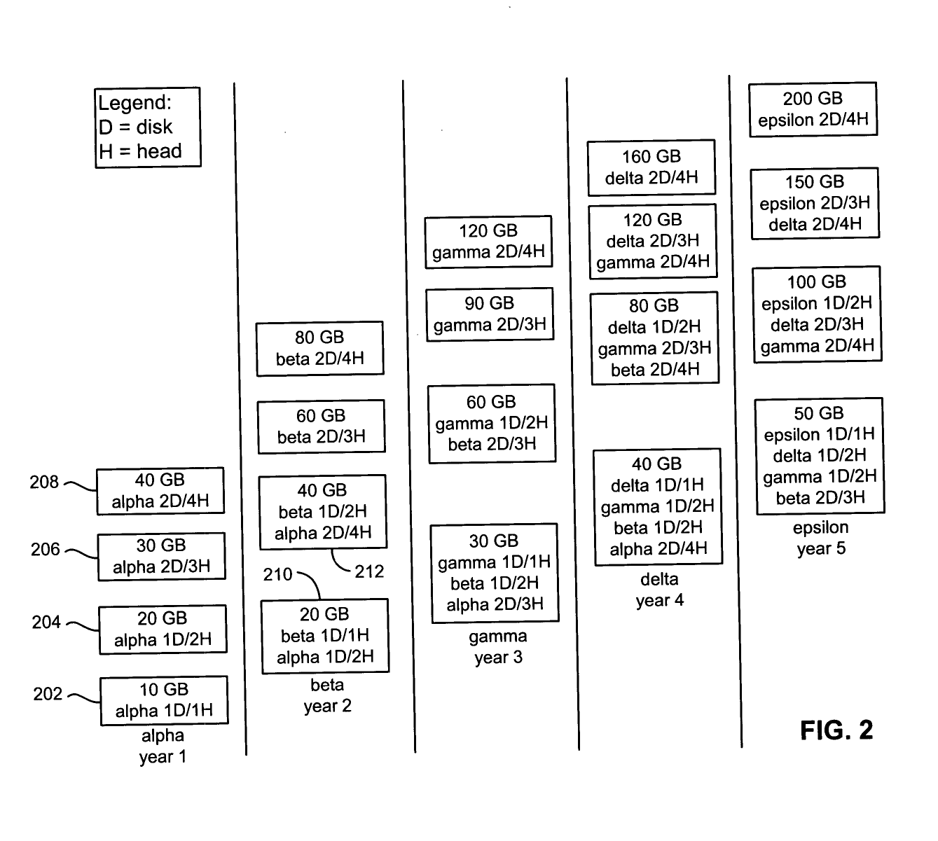

FIG. 2 illustrates several generations of disk drives, each generation having a family of drives. The generations/families ascend in the following order: alpha, beta, gamma, delta, and epsilon, each family being a “next generation” family relative to the previous family. In the example shown in FIG. 2, the base model of each family increases an additional 10 GB capacity over the base product of the previous year. Heads in the same generation have double the capacity of the drive below it.

Focusing on the alpha family, the base drive 202 has one disk and one head providing a capacity of 10 GB. The second drive 204 has a capacity of 20 GB, which is provided by one disk and two heads. The third drive 206 has two disks and three heads, providing a capacity of 30 GB. The fourth drive 208 has two disks and four heads, providing a capacity of 40 GB. Once the manufacturer has perfected the components for the alpha family, it will have the capacity to mass produce the components for use in all four drive types.

The beta family is a family of next generation drives relative to the alpha family. The alpha family is a legacy family relative to the beta family. As shown in FIG. 2, legacy heads are typically used for lower capacity drives while the next generation heads are used in the higher capacity drives. In this example, two of the drives 210, 212 of the beta family can use alpha heads. For example, the beta base drive 210 can achieve the 20 GB capacity using one disk and one beta head, or one disk and two alpha heads. Similarly, the 40 GB beta drive can use one disk and two beta heads, or two disks and four alpha heads.

To use alpha heads in the beta family of drives, all that may be required is to update the controlware and/or electronics, i.e., chipsets. And if the performance of the legacy alpha heads is not as good as the next generation beta heads, the beta drive can be optimized to provide about the same performance as if next generation beta heads were used. Further, if the legacy alpha head has a wider track width than the beta head, more of the disk area can be used to achieve the desired disk capacity. For instance, unused disk area may be available, as high performance drives use very short stroking, leaving fringes of the disk unused. Thus, the next generation beta drives will provide the next generation benefits (e.g., better error rate detection, improved modeling, etc.), even though legacy alpha heads are used. Thus, end consumers will not see a significant difference in performance or capacity.

The principles set forth herein are very advantageous. Because legacy components can be used in next generation drives with similar performance and capacity as if next generation components were used, the strain on the manufacturer is greatly reduced. If the manufacturer were to use all next generation heads immediately, the production process must ramp up very quickly. This means that the heads must be created, tested, and the production line finalized.

Using the methodology proposed here in relation to heads, for example, the manufacturer need only ramp production of the next generation heads to quantities necessary to produce the higher capacity drives. In other words, if legacy heads are used in some models, the manufacturer can ramp up at a more reasonable rate instead of focusing all efforts on creating a production line that can produce sufficient quantities of next generation heads for the entire line in a short time frame. As mentioned above, a typical time to create a wafer turn and receive data from drive level testing is six months. So, for example, to create a new product line each year, the manufacturer would only be able to take two wafer turns to optimize the heads for real world conditions. It would be much easier on the manufacturer if the demand on the next generation family is 10% instead of 100%, the other 90% being fulfilled by drives with legacy heads which can be created in high yield. For example, legacy heads can be used in about 25-95% of drives in a family of next generation drives, as measured by total number of drives sold, as a percentage of family members sold with legacy heads (e.g., 4 of 8 models use legacy heads), etc.

Thus, one advantage of the proposed methodology is that the proposed process allows the manufacturer to slow down the conversion of the line to the next generation heads, allowing more time to optimize the heads to use.

Another advantage is that the life of the legacy product is extended. This is particularly advantageous, because the manufacturer has already expended much money and resources in developing the product and production line. Thus, the manufacturer sees more return on investment.

And while a particular drive may require more legacy components, they are cheaper, more readily available (can be produced in bulk using the existing production line), and are fully tested and optimized.

While various embodiments have been described above, it should be understood that they have been presented by way of example only, and not limitation. For example, the structures and methodologies presented herein are generic in their application to all mobile, desktop and server disk drives, disk media, sliders, arms, and other disk drive components, as well as tape drives and its components. Thus, the breadth and scope of a preferred embodiment should not be limited by any of the above-described exemplary embodiments, but should be defined only in accordance with the following claims and their equivalents.

1. A method for manufacturing a disk drive, comprising:
installing at least one legacy head in a first next generation disk drive of a prespecified capacity;
modifying control parameters of the first disk drive for functioning with the at least one legacy head for providing the prespecified capacity.

2. The method as recited in claim 1, wherein a second next generation disk drive of the same data capacity but in a same family of drives contains a next generation head.

3. The method as recited in claim 2, wherein a data read rate of each of the disk drives is about the same.

4. The method as recited in claim 2, wherein a data write rate of each of the disk drives is about the same.

5. The method as recited in claim 2, wherein at least two legacy heads are used to achieve the same disk capacity in the first next generation disk drive as is achieved in the second next generation disk drive.

6. The method as recited in claim 1, wherein a second next generation disk drive of a higher data capacity but in a same family of drives contains a next generation head.

7. The method as recited in claim 1, wherein legacy heads are used in at least 50% of drives in a family of next generation drives.

8. The method as recited in claim 1, wherein legacy heads are used in at least 25% of drives in a family of next generation drives.

9. A method for manufacturing a disk drive, comprising:
installing at least one legacy component in a first next generation disk drive of a prespecified capacity;
modifying control parameters of the first disk drive for functioning with the at least one legacy component for providing the prespecified capacity.

10. The method as recited in claim 9, wherein the component is a disk head.

11. The method as recited in claim 9, wherein the component is a slider.

12. A method for manufacturing a tape drive, comprising:
installing at least one legacy component in a next generation tape drive of a prespecified data rate;
modifying control parameters of the tape drive for functioning with the at least one legacy component for providing the prespecified capacity.

13. The method as recited in claim 12, wherein the component is a read head.

14. The method as recited in claim 12, wherein the component is a write head.
